(19) United States
(12) Patent Application Publication
(10) Pub. No.: US 2019/0021371 A1
(43) Pub. Date: Jan. 24, 2019

(54) METHODS FOR PREPARING FROZEN ONION SOUP AU GRATIN

(71) Applicant: LES PLATS DU CHEF INC., Dollard-des-Ormeaux (CA)

(72) Inventor: Jean-Marie OUELLETTE, Notre-Dame de l'lle Perrot (CA)

(21) Appl. No.: 16/138,544

(22) Filed: Sep. 21, 2018

Related U.S. Application Data
(63) Continuation of application No. 14/772,899, filed on Sep. 4, 2015.
(60) Provisional application No. 61/775,981, filed on Mar. 11, 2013.

(51) Int. Cl. A23L 3/36; A23P 20/12; A23L 23/00; A23P 20/20; A23L 35/00

(52) U.S. Cl. CPC A23L 3/364; A23L 3/36; A23V 2002/00; A23L 35/00; A23L 23/00; A23P 20/20; A23P 20/12

(57) ABSTRACT

There is provided a method for preparing a frozen onion soup au gratin, wherein heating of the frozen onion soup au gratin produces an onion soup au gratin comprising, in the following order from bottom to top: a first layer comprising onion soup, a second layer comprising at least one partially submerged bread piece or crouton and a third layer comprising gratinated cheese, wherein the first layer remains substantially free of immerged cheese.

### CROSS-REFERENCE TO RELATED APPLICATIONS

The present application is a continuation of U.S. patent application Ser. No. 14/772,899 filed on Sep. 4, 2015, that is a 35 USC 371 national stage entry of PCT/CA2014/000159 filed on Feb. 28, 2014 and which claims priority on U.S. 61/775,981 filed on Mar. 11, 2013. These documents are all hereby incorporated by reference in their entirety.

### FIELD OF THE DISCLOSURE

The present disclosure generally relates to the field of frozen food products. In particular, the present disclosure relates to methods for preparing a frozen onion soup au gratin.

### BACKGROUND OF THE DISCLOSURE

Onion soup au gratin, also referred to as French onion soup, is a popular food product. It typically comprises a layer of one or more types of gratinated cheese on top of a layer of, for example, at least one bread piece or at least one crouton, which, in turn, floats substantially on top of a bottom layer comprising onion soup.

Known methods for the preparation of onion soup au gratin are typically time-consuming in nature for the home or commercial chef. For example, first the onion soup must be prepared, and a layer of this onion soup deposited into each of one or more ovenproof vessels, for example, ovenproof bowls. Then, a layer of, for example, croutons or bread cubes or slices is deposited on top of the layer of onion soup. Next, a layer of one or more types of cheese is deposited on top of the layer of croutons or bread cubes or slices. Finally, the one or more ovenproof vessels containing the layers of onion soup, croutons or bread cubes or slices and cheese is baked in an oven for a time and temperature sufficient to melt and optionally brown the cheese without burning the croutons or bread cubes or slices.

Alternative methods for the preparation of onion soup au gratin are also known, wherein the onion soup is frozen after its preparation. Then, on the day the onion soup au gratin is to be prepared, the frozen soup can be reheated, and the method described above can be continued as appropriate. While such methods reduce the amount of time required for the preparation of onion soup au gratin on the day the onion soup au gratin is prepared, such methods do not reduce the total time spent preparing the onion soup au gratin.

Using, for example, an oven to reheat a commercially available pre-assembled frozen food product is a known means of reducing the time needed to prepare the corresponding hot food product. Accordingly, a pre-assembled frozen onion soup au gratin would be expected to reduce the total amount of time a consumer spends preparing an onion soup au gratin.

However, known examples of such pre-assembled frozen onion soup au gratin are reported to possess undesirable qualities. In particular, reheating known examples of pre-assembled frozen onion soup au gratin has been reported to result in the swelling of the croutons with onion soup to an extent that the croutons sink to the bottom of the layer comprising onion soup. The layer of cheese on top of the croutons has also been reported to sink into the layer comprising onion soup. This would be expected to result in a reheated soup which does not resemble the desired onion soup au gratin, for example, in either the preferred texture or taste.

Further alternative methods for preparing pre-assembled frozen onion soup au gratin are known wherein the pre-assembled frozen onion soup au gratin further comprises a layer comprising, for example, a savory compounded disc. However, such methods are known to further require, for example, the fabrication of a container specially adapted to house a bottom layer comprising onion soup, a top layer comprising cheese, and middle layers comprising the disc and a slice of bread.

### SUMMARY OF THE DISCLOSURE

It would thus be desirable to be provided with a method for preparing a frozen onion soup au gratin that would at least partially solve one of the problems mentioned or that would be an alternative to the known methods for preparing frozen onion soup au gratin.

Accordingly, there is provided a method for preparing a frozen onion soup au gratin, the method comprising:

preparing an onion soup slush from an onion soup;

depositing the onion soup slush into a mold to obtain a first layer;

depositing a second layer comprising at least one bread piece or at least one crouton on the first layer;

depositing a third layer comprising cheese on the second layer; and

freezing the first layer, the second layer and the third layer to obtain the frozen onion soup au gratin.

It was found that by using such a method, it was possible to prepare a frozen onion soup au gratin, wherein heating of the frozen onion soup au gratin produces an onion soup au gratin comprising onion soup, at least one bread piece or at least one crouton and gratinated cheese, wherein the at least one bread piece or at least one crouton remains substantially on top of the onion soup so that it is only partially submerged in the onion soup, and the gratinated cheese remains substantially on top of the at least one bread piece or at least one crouton, so that the onion soup remains substantially free of immerged cheese.

Other features and advantages of the present disclosure will become apparent from the following detailed description. It should be understood, however, that the detailed description and the specific examples while indicating embodiments of the present disclosure are given by way of illustration only, since various changes and modifications within the spirit and scope of the present disclosure will become apparent to those skilled in the art from this detailed description.

### BRIEF DESCRIPTION OF THE DRAWINGS

The following drawings represent examples that are presented in a non-limitative manner.

FIG. 1 shows a flowchart of an embodiment of a method for preparing a frozen onion soup au gratin.

FIG. 2 shows a flowchart of another embodiment of a method for preparing a frozen onion soup au gratin.

FIG. 3 shows an exemplary frozen onion soup au gratin prepared by an embodiment of the methods of the present disclosure.

### DETAILED DESCRIPTION OF THE DISCLOSURE

Unless otherwise indicated, the definitions and embodiments described in this and other sections are intended to be applicable to all embodiments and aspects of the present disclosure herein described for which they are suitable as would be understood by a person skilled in the art.

As used in the present disclosure, the singular forms “a”, “an” and “the” include plural references unless the content clearly dictates otherwise. For example, an embodiment including “a cheese” should be understood to present certain aspects with one cheese, or two or more additional cheeses.

In embodiments comprising an “additional” or “second” component, such as an additional or second cheese, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The term “onion soup slush” as used herein refers to a semi-frozen state of onion soup, for example a state of onion soup having a frozen portion and an unfrozen portion, wherein the frozen portion comprises a plurality of frozen particles, for example crystals of onion soup which are, for example, substantially uniformly distributed throughout a matrix comprising the unfrozen onion soup. For example, the onion soup slush may comprise about 75% to about 95% or about 85% ice crystals based on a visual estimate of the volume percent of ice crystals in the onion soup slush. For example, the density of the onion soup slush has been measured to be from about 1.01 g/mL to about 1.07 g/mL, about 1.02 g/mL to about 1.06 g/mL or a mean of about 1.04 g/mL

The term “crouton” as used herein refers, for example to a piece of bread in which the water content has been lowered to the extent that the piece of bread is, for example, at least partially hard or crisp. The selection of a method for preparing a crouton can be made by a person skilled in the art. For example, a crouton may be prepared, for example by toasting, roasting, drying, microwaving, baking, lyophilizing or frying a piece of bread. Alternatively, a crouton is available through a commercial source.

The term “bread” as used herein refers to, for example, a food product comprising flour and includes, for example, a leavened bread, for example a yeast bread or a quick bread, an unleavened bread, a gluten-free bread, a cracker, a biscuit or a wafer. The selection of a suitable bread as well as a method of preparing the bread can be made by a person skilled in the art.

The term “bread piece” as used herein includes, for example a bread slice, a bread strip, a bread cube and torn bread.

The expression “partially submerged bread piece or crouton” as used herein refers to a bread piece or crouton which has absorbed an amount of the liquid onion soup comprising the first layer of the onion soup au gratin of the methods of the present disclosure less than the amount which would cause the bread piece or crouton to be submerged substantially below the surface of the first layer.

The term “gratinated” as used herein refers to cheese that has been melted and optionally browned. For example, cheese may be gratinated by placing the cheese in an oven for a time and temperature so that the cheese melts, and optionally browns but not so long as to burn the cheese.

The expression “immerged cheese” as used herein refers to cheese present below the surface of the liquid onion soup comprising the first layer of the onion soup au gratin of the methods of the present disclosure.

The expression “first layer substantially free of immerged cheese” and the like as used herein refers, for example, to a first layer of the onion soup au gratin of the methods of the present disclosure in which less than about 30, 25, 20, 15, 10, 5, 4, 3, 2 or 1% by weight of the cheese is immerged in the soup.

The expression “the onion soup remains substantially free of immerged cheese” and the like as used herein refers, for example, to the onion soup au gratin of the methods of the present disclosure in which less than about 30, 25, 20, 15, 10, 5, 4, 3, 2 or 1% by weight of the cheese is immerged in the soup.

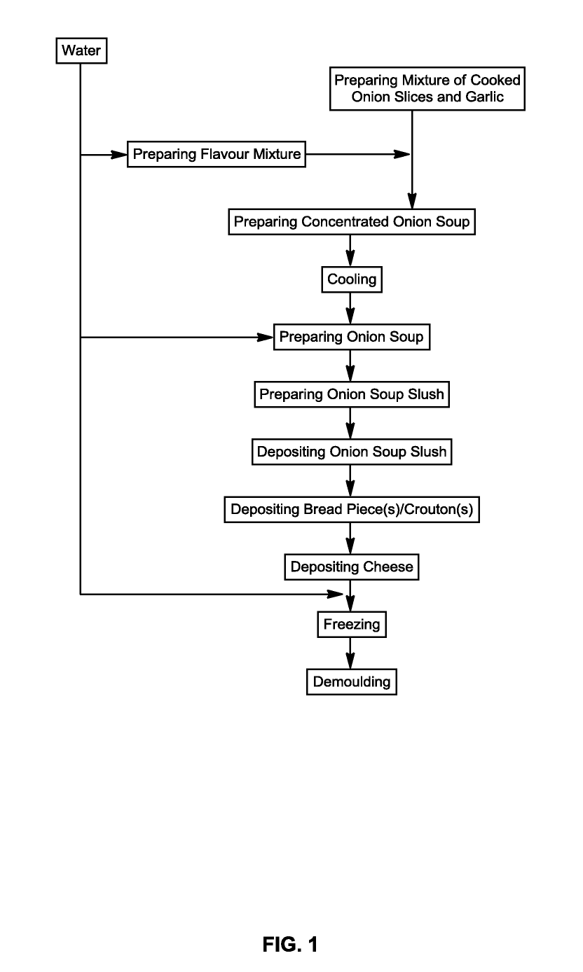

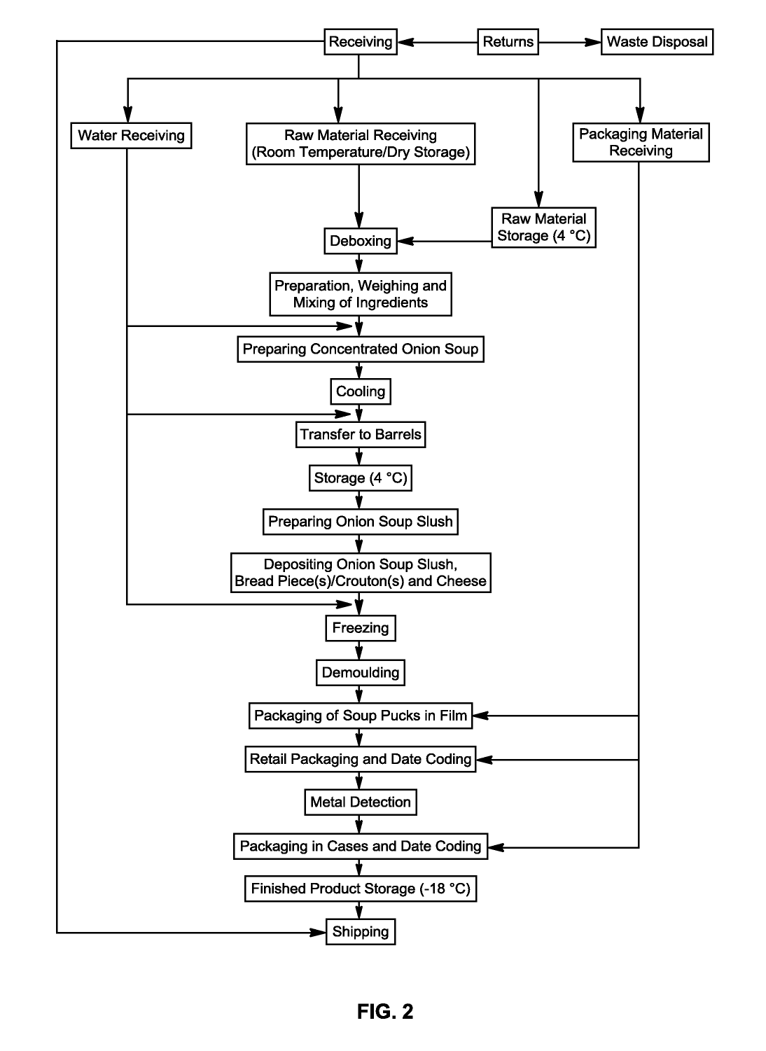

For example, the onion soup slush can be prepared from the onion soup (see FIGS. 1 and 2) by passing the onion soup through a heat exchanger. It was found that the semi-frozen state of the onion soup slush allows for keeping the cooked onion slices therein in suspension and provides a support for the at least one bread piece or at least one crouton and the cheese so that there is no substantial amount of sinkage of either the at least one bread piece or at least one crouton or the cheese into the first layer comprising the onion soup slush during subsequent steps of the methods of the present disclosure. For example, the heat exchanger can have at least one inlet to receive the onion soup and at least one outlet to output the onion soup slush. For example, the at least one outlet can be vertically above the at least one inlet. For example, the heat exchanger can have a channel for passing cooling media. For example, the temperature of the cooling media can be from about −18° C. to about −3° C. or about −15° C. to about −5° C. For example the cooling media can pass through the channel countercurrent to the onion soup. For example, the heat exchanger can be chosen from a plate heat exchanger, a tubular heat exchanger and a scraped surface heat exchanger. For example, the heat exchanger can be a scraped surface heat exchanger. For example, the scraped surface heat exchanger can have at least one blade for removing onion soup and/or onion soup slush from an interior wall of the scraped surface heat exchanger. For example, the at least one blade can be rotating. For example, the heat exchanger can be a Contherm™ heat exchanger such as a Contherm Scraped Surface Heat Exchanger.

For example, the onion soup can be obtained from a commercial source or it may be a customized onion soup. For example, in the methods of the present disclosure, the onion soup can be prepared by slicing a plurality of freshly peeled uncooked onions to give a plurality of uncooked onion slices, combining the plurality of uncooked onion slices with a plurality of freshly peeled uncooked garlic cloves (for example the garlic can be frozen, peeled and diced (⅛″×⅛″×⅛″) and converted into a puree), cooking the plurality of uncooked onion slices with the plurality of freshly peeled uncooked garlic cloves under conditions to give a mixture of cooked onion slices and garlic, adding a flavor mixture to the mixture of cooked onion slices and garlic to give a flavored suspension of cooked onion slices and garlic, cooking the flavored suspension of cooked onion slices and garlic under conditions to give a concentrated onion soup, cooling the concentrated onion soup using a cooling vessel under conditions to give a cooled concentrated onion soup, and adding water to the cooled concentrated onion soup to give onion soup (see FIGS. 1 and 2). The onion soup can be transferred to one or more storage vessels, for example barrels, the one or more storage vessels can then be stored in a cooler, and then the onion soup pumped from one or more of the one or more storage vessels to a holding vessel before being pumped to a heat exchanger (see FIG. 2). For example, the storage vessel can comprise a barrel.

For example, the flavor mixture can be prepared, for example by mixing one or more dry ingredients with a base and water using, for example, a high shear mixer to form the flavor mixture (see FIG. 1).

For example, the plurality of uncooked onion slices can have an average slice thickness of about 2.0 mm to about 4.3 mm or about 2.5 mm to about 3.1 mm.

For example, the dry ingredients can be chosen from one or more of food ingredients, spices, seasonings, flavoring preparations, thickening agents and food additives. For example, the dry ingredients can be chosen from one or more of salt, pepper, thyme, flour, beef flavor powder, sugar, flavor enhancer, yeast extract and food gum. For example, the dry ingredients can comprise, consist essentially of or consist of salt, pepper, thyme, flour, beef flavor powder, sugar, flavor enhancer, yeast extract and food gum. The dry ingredients used, and the relative amounts used of the dry ingredients can vary, and will depend, for example, on the particular conditions used for the preparation of the frozen onion soup au gratin, the other ingredients used in the preparation of the frozen onion soup au gratin and the taste desired for an onion soup au gratin prepared from the frozen onion soup au gratin. The selection of suitable dry ingredients for the methods of the present disclosure and the relative amounts thereof can be made by a person skilled in the art.

Other ingredients can also be added such as a liquid colouring agent (for example a caramel colour).

For example, the base can be, for example, in the form of a paste, comprising, consisting essentially of or consisting of one or more of a beef base, an onion base and a mirepoix base. For example, the base can comprise, consist essentially of or consist of a beef base, an onion base and a mirepoix base. For example, the beef base can comprise beef and one or more additional components, for example but not limited to food ingredients, spices, seasonings and food additives. The beef base can be obtained from a commercial source or it may be a customized beef base. The selection and/or preparation of a suitable beef base for the methods of the present disclosure can be made by a person skilled in the art. For example, the onion base can comprise onions, and one or more additional components, for example but not limited to food ingredients, spices, seasonings and food additives. The onion base can be obtained from a commercial source or it may be a customized onion base. The selection and/or preparation of a suitable onion base for the methods of the present disclosure can be made by a person skilled in the art. For example, the mirepoix base can comprise one or more of celery, onions and carrots, and optionally one or more additional components, for example but not limited to food ingredients, spices, seasonings and food additives. The mirepoix base can be prepared from, for example, a raw mirepoix, a roasted mirepoix or a mirepoix that has been sautéed with a source of fat, for example butter or olive oil. The mirepoix base can be obtained from a commercial source or it may be a customized mirepoix base. The selection and/or preparation of a suitable mirepoix base for the methods of the present disclosure can be made by a person skilled in the art.

For example, the composition of the onion soup can comprise from about 50 wt % to about 70 wt % or about 58 wt % water, about 30 wt % to about 45 wt % or about 36 wt % onions and garlic, and about 3.5 wt % to about 8 wt % or about 6 wt % base and dry ingredients.

For example, the conditions to give the mixture of cooked onion slices and garlic can comprise cooking the plurality of uncooked onion slices with the plurality of freshly peeled uncooked garlic cloves for a time of about 55 minutes to about 1.5 hours or about 1 hour to about 1.25 hours at a temperature of about 90° C. to about 105° C. or about 102° C. to about 105° C.

For example, the conditions to give the concentrated onion soup can comprise cooking the flavored suspension of cooked onion slices and garlic for a time of about 0.1 hours to about 0.5 hours or about 0.3 hours at a temperature of about 74° C. to about 95° C. or about 85° C. to about 90° C.

For example, a kettle such as a horizontal kettle with continuous agitation can be used to cook the plurality of uncooked onion slices with the plurality of freshly peeled uncooked garlic cloves and/or used to the cook the flavored suspension of cooked onion slices and garlic.

For example, the cooling vessel can comprise a vacuum cooling vessel.

For example, the conditions to give the cooled concentrated onion soup can comprise cooling the concentrated onion soup at a pressure of from about 980 mbar to about 1050 mbar or about 1013 mbar down to a pressure of about 10 mbar to about 60 mbar or about 25 mbar for a time of about 30 minutes to about 90 minutes or about 60 to about 75 minutes down to a temperature of about 2° C. to about 5° C. or about 4° C.

For example, the water added to form the onion soup from the cooled concentrated onion soup can be from about 800 L to about 1200 L or about 975 L to about 1050 L. The volume of cooled concentrated onion soup can be about 1150 kg to 1275 kg or about 1050 kg to 1450 kg.

For example, each of the one or more barrels can have a capacity of about 50 L to about 400 L, about 100 L to about 300 L, about 150 L to about 250 L, about 190 L to about 210 L or about 200 L.

For example, the one or more barrels can be stored in the cooler for a time of about 5 hours to about 6 days or about 5 hours to about 48 hours at a temperature of about 1° C. to about 4° C. or about 4° C.

For example, the holding vessel can have continuous agitation, for example to keep the solids in suspension. For example, a cylindrical holding vessel can be agitated by one horizontal shaft. For example, 6 blades parallel to the horizontal shaft can rotate at about 5 to about 10 rpm, or about 7 to about 8 rpm or at about 7.25 rpm. For example, the blades can cover the whole length of the vessel and the end of the blade can be about 1 cm to about 2 cm away from the wall of the holding vessel. For example, the horizontal shaft can rotate in only one direction.

For example, in the methods of the present disclosure, the onion soup slush can be deposited into the mold to obtain the first layer using a volumetric portioner (see FIGS. 1 and 2). For example, the volumetric portioner can be configured to portion from 2 to 4 molds or 4 molds at a time. For example, the volumetric portioner can be configured to portion more than 4 molds at a time so long as the heat exchanger can remove the amount of heat needed to be removed per minute for a particular number of molds filled per minute. A suitable number of molds for a particular system can be determined by a person skilled in the art, and will depend, for example on the heat exchanger used, the temperature of the onion soup pumped into the heat exchanger, the temperature of the cooling media in the heat exchanger, the density of the onion soup slush being produced and the size of the mold.

The selection of a suitable material to comprise the mold can be made by a person skilled in the art. For example, such a material should have a conductivity factor that fits a particular production line set-up for preparing frozen onion soup au gratin, for example it should at least partially allow the onion soup slush to remain as an onion soup slush until the onion soup slush in the mold reaches the freezer, for example the spiral freezer; it should allow at least a portion of the heat from the one or more radiant heaters to go through the mold so that the contents of the mold can be demolded; and it should be a material acceptable for use in food preparation and/or packaging applications. For example, the mold can comprise, consist essentially of or consist of a polyethylene, a polypropylene, a poly(ethylene-vinyl acetate), a polystyrene, a polyvinyl chloride, a polyethylene terephthalate, a polyvinyl acetate, a polycarbonate, a polyamide, a polyvinyl alcohol or a polyvinylidene chloride meeting, for example the above-discussed characteristics. For example, the mold can comprise, consist essentially of or consist of a polypropylene, for example a polypropylene copolymer, for example Pro-fax SV956.

The shape and/or dimensions of the mold can be chosen by a person skilled in the art. For example, the mold can be a bowl having a bottom diameter of from about 2 inches to about 8 inches or about 3 inches, a top diameter of about 2 inches to about 9 inches or about 3 inches, a height of about 1 inch to about 10 inches or about 5 inches and a wall thickness of about 0.02 inches to about 0.10 inches or about 0.06 inches.

For example, it was found that it is useful to deposit the onion soup slush into the mold at a temperature below about −0.2° C. so that the at least one bread piece or crouton will not be submerged substantially below the surface of the first layer, and so that the first layer will be substantially free of immerged cheese. For example, it was found that it is useful to deposit the onion soup slush into the mold at a temperature above about −2.0° C. because below that temperature the onion soup slush may become frozen onion soup within the pipes of the system used for preparing the frozen onion soup au gratin in the methods of the present disclosure. For example, a temperature useful for depositing the onion soup slush into the mold was found to be about −0.4° C. Accordingly, in the methods of the present disclosure, the temperature at which the onion soup slush can be deposited into the mold can be for example, from about −2.0° C. to about −0.2° C. or about −0.4° C.

For example, in the methods of the present disclosure, the second layer comprising the at least one bread piece or at least one crouton can be deposited on the first layer using, for example, a volumetric portioner (see FIGS. 1 and 2). For example, the volumetric portioner can comprise a hopper, a drawer and a funnel. For example, the hopper can comprise a container for holding bread pieces and/or croutons, and the drawer (a sliding gate) can be coupled to the hopper, for example at a bottom end of the hopper. For example, when the drawer is closed, one or more openings in the drawer can be aligned with the bottom of the hopper, allowing the bread pieces and/or croutons to fall into the one or more openings so that the one or more openings are filled with at least one bread piece or at least one crouton. For example, then the drawer can be moved to align the one or more filled openings with the funnel to deposit the at least one bread piece or at least one crouton into the funnel through an upper opening in the funnel so that, for example, the at least one bread piece or at least one crouton will then be deposited into a mold that is aligned underneath a lower opening in the funnel. For example, from about 3 grams to about 7 grams or about 4 grams to about 5 grams of the at least one bread piece or at least one crouton is deposited on the first layer.

For example, the at least one bread piece or at least one crouton can be pushed into the first layer comprising the onion soup slush using a piston, for example an air-actuated cylinder. For example, the at least one bread piece or at least one crouton in each mold is pushed in using one air-actuated cylinder so that if 4 molds are being prepared, the system uses four air-actuated cylinders. On each air-actuated cylinder, a disc, for example a stainless steel disc is coupled, for example welded to a bottom end of the cylinder. For example, the diameter of the disc depends on the top diameter of the mold, and is less than the top diameter of the mold. For example, one or more projections having a substantially cylindrical shape can be coupled, for example welded to a bottom side of the disc so that the projections engage with the at least one bread piece or at least one crouton to push the at least one bread piece or at least one crouton into the first layer comprising the onion soup slush. For example, the air-actuated cylinder does not require a waiting time before or after the at least one bread piece or at least one crouton is pushed into the first layer comprising the onion soup slush.

For example, the at least one bread piece or at least one crouton can be pushed into the first layer comprising the onion soup slush so that a bottom end of the at least one bread piece or at least one crouton is about 0.8 cm to about 1.2 cm or about 1 cm below the surface of the first layer. Other depths may also be suitable and the choice of a suitable depth can be made by a person skilled in the art. A suitable depth, for example will allow the at least one bread piece or at least one crouton to move and be side-by-side with one or more other bread pieces or one or more other croutons, and allow the layer of cheese to sit on an approximately planar surface so that the layer of cheese forms a substantially uniform third layer. For example, without an approximately planar surface, the cheese may be at least partially in direct contact with the onion soup slush, and may sink below the surface of the onion soup slush so that it may lead to an onion soup au gratin that does not comprise a first layer substantially free of immerged cheese.

For example, in the methods of the present disclosure, the third layer comprising cheese can be deposited on the second layer using, for example, a portioner with a hook (see FIGS. 1 and 2). The cheese can be, for example, in the form of pieces having dimensions of about 1/16 inch× 1/16 inch× 1/16 inch to about ½ inch×½ inch×½ inch or about ⅛ inch×⅛ inch×⅛ inch. For example, the cheese can be in the form of shredded cheese, and it can be portioned using a portioner suitable for portioning shredded cheese. The selection of a portioner suitable for portioning shredded cheese can be made by a person skilled in the art.

For example, the cheese can comprise, consist essentially of or consist of one or more of Swiss cheese, mozzarella cheese, Monterey Jack cheese, Asiago cheese and cheddar cheese. Similar cheeses to the above may also be used either individually or in a cheese blend. For example, a single cheese or a cheese blend (i.e. a mixture of two or more cheeses) may be used in the methods of the present disclosure. For example, the cheese may comprise, consist essentially of or consist of Swiss cheese. The selection of a suitable cheese for the methods of the present disclosure can be made by a person skilled in the art, and will depend, for example on the desired flavor, the capacity of the cheese or cheese blend to be gratinated, and the like.

For example, in the methods of the present disclosure, the third layer comprising cheese can be optionally sprayed with water. It was found that spraying water on the surface of the cheese sticks the cheese pieces together.

For example, in the methods of the present disclosure, the first layer, the second layer and the third layer (i.e. the contents of the mold) can be frozen by transferring the mold to a freezer, for example, a spiral freezer for a time of about 90 minutes to about 100 minutes or about 1.5 hours at an ambient freezer temperature of about −15° C. to about −45° C. or about −30° C. to about −32° C. (see FIGS. 1 and 2). It was found that if the surface temperature of the frozen onion soup au gratin is greater than about −7° C. then the core of the frozen onion soup au gratin may not be frozen. This can, for example produce spillage in the packaging. Accordingly, it is useful if the surface temperature of the frozen onion soup au gratin can be substantially maintained at, for example no greater than about −10° C. to about −7° C. or about −8° C.

For example, in the methods of the present disclosure, the first layer, the second layer and the third layer (i.e. the contents of the mold) can be demolded using, for example, one or more radiant heaters, for example infrared radiant heaters to give a demolded soup and a used mold (see FIGS. 1 and 2). For example, the molds can be passed through two tunnels, each tunnel having three infrared radiant heaters. For example the infrared radiant heaters can have a temperature of about 55° C. to about 70° C. For example, the tunnel can be about 6 meters long. For example, each mold will stay in each tunnel for about 5.5 seconds. It was found that the sides of the mold are thus heated enough to thaw the first layer of ice, and to release the frozen soup from the mold. For example, the mold can be manually removed.

For example, the used mold can optionally be washed to give a washed mold, for example by transferring the mold to a washing machine, and the washed mold can subsequently be returned to the step of the methods of the present disclosure comprising depositing the onion soup slush into the mold to obtain the first layer.

For example, in the methods of the present disclosure, the demolded soup or “soup puck” can be, for example, manually put into, for example, a single cavity of a formed plastic film such as, for example, Multivac™ and then the formed plastic film sealed around the demoulded soup, for example, by vacuum (see FIG. 1). For example, the vacuum sealed soup pucks can then optionally be subjected to one or more of the following steps: packaging in retail packaging and date coding, metal detection, packaging in cases and date coding, storing and shipping (see FIG. 1).

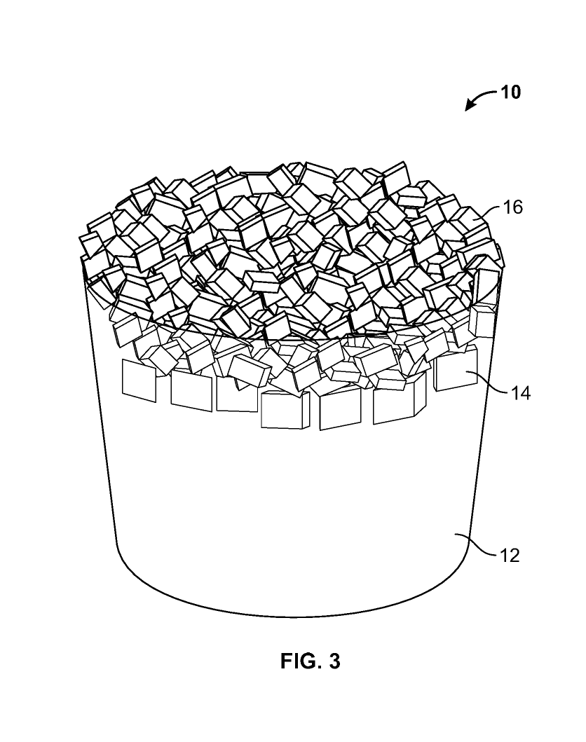

For example, in the methods of the present disclosure, the frozen soup obtained can be as shown in FIG. 3. The frozen onion soup au gratin 10 shown in FIG. 3 under the form of a frozen “soup puck” comprises onion soup 12, croutons 14 and cheese 16.

The frozen onion soup au gratin prepared by the methods of the present disclosure can be stored, for example at an ambient freezer temperature of about −15° C. to about −20° C. or about −18° C. (see FIG. 1).

For example, the frozen onion soup au gratin prepared by the methods of the present disclosure can be cooked, for example using a conventional oven or a microwave oven under conditions to prepare an onion soup au gratin. For example, the conditions to prepare an onion soup au gratin using a conventional oven can comprise pre-heating the oven to about 400° F., placing an unpacked frozen onion soup au gratin in an ovenproof vessel, for example a bowl (more particularly an onion soup bowl) in a configuration so that the layer comprising cheese is on top, and heating the frozen onion soup au gratin in the conventional oven until the cheese is gratinated, for example for about 35 minutes to about 45 minutes or about 40 minutes. For example, the conditions to prepare an onion soup au gratin using a microwave oven can comprise placing an unpacked frozen onion soup au gratin in a microwave-safe vessel, for example a bowl in a configuration so that the layer comprising cheese is on top, and heating the frozen onion soup au gratin in the microwave oven, for example a 1000 W microwave oven until the cheese is gratinated, for example for about 7 minutes to about 9 minutes or about 8 minutes on HIGH, optionally stirring at mid-heating point. The conditions, for example the temperatures and times needed to cook the frozen onion soup au gratin to prepare an onion soup au gratin will vary, for example, depending on the conventional oven or the microwave oven used, the dimensions of the frozen onion soup au gratin, and the elevation above sea level the onion soup au gratin is being cooked. The choice of suitable conditions to prepare an onion soup au gratin from a frozen onion soup au gratin can be made by a person skilled in the art. For example, instructions regarding suggested conditions to prepare an onion soup au gratin from a frozen onion soup au gratin can be included with or on the material the frozen onion soup au gratin is packaged in.

For example, heating of the frozen onion soup au gratin can produce an onion soup au gratin comprising, in the following order from bottom to top: a first layer comprising onion soup, a second layer comprising at least one partially submerged bread piece or crouton and a third layer comprising gratinated cheese, wherein the first layer remains substantially free of immerged cheese.

For example, the frozen onion soup au gratin when heated can produce an onion soup au gratin in which is found, in the following order from top to bottom: gratinated cheese on at least one bread piece or at least one crouton that is on the onion soup, without however having a significant portion of the cheese immerged into the onion soup.

The person skilled in the art would understand that the various properties or features presented in a given embodiment can be added and/or used, when applicable, to any other embodiment covered by the general scope of the present disclosure.

The present disclosure has been described with regard to specific examples. The description was intended to help the understanding of the disclosure, rather than to limit its scope. It will be apparent to one skilled in the art that various modifications can be made to the disclosure without departing from the scope of the disclosure as described herein, and such modifications are intended to be covered by the present document.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1. A method for preparing a frozen onion soup au gratin, said method comprising:
preparing an onion soup slush from an onion soup by passing the onion soup through a heat exchanger, the onion soup slush comprising a plurality of frozen particles substantially uniformly distributed throughout a matrix of unfrozen onion soup, the onion soup slush having a density from about 1.01 g/mL to about 1.07 g/mL and comprising about 75% to about 95% of ice crystals based on the volume percent of ice crystals in the onion soup slush;
pumping the onion soup slush into a mold to obtain a first layer at a temperature of from about −2.0° C. to about −0.2° C.;
depositing a second layer comprising at least one bread piece or at least one crouton on the first layer;
depositing a third layer comprising cheese on the second layer; and
freezing the first layer, the second layer and the third layer in a freezer to obtain said frozen onion soup au gratin.

2. The method of claim 1, wherein the heat exchanger has at least one inlet to receive the onion soup and at least one outlet to output the onion soup slush.

3. The method of claim 2, wherein the at least one outlet is vertically above the at least one inlet.

4. The method of claim 1, wherein the heat exchanger has a channel for passing cooling media.

5. The method of claim 4, wherein the temperature of the cooling media is from about −18° C. to about −3° C.

6. The method claim 1, wherein the heat exchanger is chosen from a plate heat exchanger, a tubular heat exchanger and a scraped surface heat exchanger.

7. The method of claim 6, wherein the heat exchanger is a scraped surface heat exchanger.

8. The method of claim 7, wherein the scraped surface heat exchanger has at least one blade for removing onion soup and/or onion soup slush from an interior wall of the scraped surface heat exchanger.

9. The method of claim 1, wherein the freezer is a spiral freezer.

10. The method of claim 9, wherein the first layer, the second layer and the third layer are frozen to give a frozen onion soup au gratin for a time of about 1.5 hours at an ambient freezer temperature of about −30° C. to about −32° C.

11. A method for preparing a frozen onion soup au gratin, said method comprising:
preparing an onion soup slush from an onion soup, the onion soup slush comprising a plurality of frozen particles substantially uniformly distributed throughout a matrix of unfrozen onion soup, the onion soup slush having a density from about 1.01 g/mL to about 1.07 g/mL and comprising about 75% to about 95% of ice crystals based on the volume percent of ice crystals in the onion soup slush;
pumping the onion soup slush into a mold to obtain a first layer at a temperature of from about −2.0° C. to about −0.2° C.;
depositing a second layer comprising at least one bread piece or at least one crouton on the first layer;
depositing a third layer comprising cheese on the second layer; and
freezing the first layer, the second layer and the third layer in a spiral freezer to obtain said frozen onion soup au gratin;
wherein the onion soup is prepared by steps comprising:
slicing a plurality of freshly peeled uncooked onions to give a plurality of uncooked onion slices;
combining the plurality of uncooked onion slices with a plurality of freshly peeled uncooked garlic cloves;
cooking the plurality of uncooked onion slices with the plurality of freshly peeled garlic cloves in a horizontal kettle with continuous agitation under conditions to give a mixture of cooked onion slices and garlic;
adding a flavor mixture to the mixture of cooked onion slices and garlic to give a flavored suspension of cooked onion slices and garlic;
cooking the flavored suspension of cooked onion slices and garlic under conditions to give a concentrated onion soup;
cooling the concentrated onion soup using a cooling vessel under conditions to give a cooled concentrated onion soup; and
adding water to the cooled concentrated onion soup to give onion soup.

12. The method of claim 11, wherein the plurality of uncooked onion slices has an average slice thickness of about 2.5 mm to about 3.1 mm.

13. The method of claim 11, wherein the conditions to give the mixture of cooked onion slices and garlic comprise cooking the plurality of uncooked onion slices with the plurality of freshly peeled uncooked garlic cloves for a time of about 1 hour to about 1.25 hours at a temperature of about 102° C. to about 105° C.

14. The method of claim 13, wherein the conditions to give the concentrated onion soup comprise cooking the flavored suspension of cooked onion slices and garlic for a time of about 0.1 hours to about 0.5 hours at a temperature of about 85° C. to about 90° C.

15. The method of claim 11, further comprising:
transferring the onion soup to one or more storage vessels;
storing the one or more storage vessels in a cooler;
pumping the onion soup from one or more of the one or more storage vessels into a holding vessel; and
pumping the onion soup from the holding vessel to the heat exchanger.

16. The method of claim 15, wherein the cooling vessel comprises a vacuum cooling vessel.

17. A method for preparing a frozen onion soup au gratin, said method comprising:
preparing an onion soup slush from an onion soup, the onion soup comprises about 50 wt % to about 70 wt % water, about 30 wt % to about 45 wt % onions and garlic, and about 3.5 wt % to about 8 wt % base and dry ingredients, the onion soup slush comprising a plurality of frozen particles substantially uniformly distributed throughout a matrix of unfrozen onion soup, the onion soup slush having a density from about 1.01 g/mL to about 1.07 g/mL and comprising about 75% to about 95% of ice crystals based on the volume percent of ice crystals in the onion soup slush;
pumping the onion soup slush into a mold to obtain a first layer at a temperature of from about −2.0° C. to about −0.2° C.;
depositing a second layer comprising at least one bread piece or at least one crouton on the first layer;
depositing a third layer comprising cheese on the second layer; and
freezing the first layer, the second layer and the third layer in a spiral freezer to obtain said frozen onion soup au gratin.

18. The method claim 17, wherein the onion soup comprises about 58 wt % water, about 36 wt % onions and garlic, and about 6 wt % base and dry ingredients.

19. The method claim 17, wherein heating of the frozen onion soup au gratin produces an onion soup au gratin comprising, in the following order from bottom to top: a first layer comprising onion soup, a second layer comprising at least one partially submerged bread piece or crouton and a third layer comprising gratinated cheese, wherein the first layer remains substantially free of immerged cheese.

20. The method of claim 19, whereby said frozen onion soup au gratin when heated produces an onion soup au gratin in which is found, in the following order from top to bottom: gratinated cheese on at least one bread piece or at least one crouton that is on said onion soup, without however having a significant portion of said cheese immerged into said onion soup.
